(19) United States
(12) Patent Application Publication
(10) Pub. No.: US 2024/0239212 A1
(43) Pub. Date: Jul. 18, 2024

(54) Scooter Battery Device

(71) Applicant: Wayne R. Oakes, Allegan, MI (US)

(72) Inventor: Wayne R. Oakes, Allegan, MI (US)

(21) Appl. No.: 18/189,326

(22) Filed: Mar. 24, 2023

Related U.S. Application Data
(60) Provisional application No. 63/438,606, filed on Jan. 12, 2023.

(51) Int. Cl. B60L 50/60; B60L 50/64; B60L 53/80; B62K 5/007

(52) U.S. Cl. CPC B60L 50/66; B60L 50/64; B60L 53/80; B62K 5/007; B60L 2200/24

(57) ABSTRACT

The present invention relates to a scooter battery device for an electric mobility scooter. During use, the device provides at least one replaceable battery that can be used to extend or supplement the battery life of an electric mobility scooter, wherein the battery can be installed by a user. In two primary embodiments, the device can be used as a backup battery for an existing battery of an electric mobility scooter or as the main standalone battery of the scooter.

### CROSS-REFERENCE TO RELATED APPLICATION

The present application claims priority to, and the benefit of, U.S. Provisional Application No. 63/438,606, which was filed on Jan. 12, 2023, and is incorporated herein by reference in its entirety.

### FIELD OF THE INVENTION

The present invention relates generally to the field of electric scooter batteries. More specifically, the present invention relates to a scooter battery device. During use, the device provides at least one replaceable battery that can be used to extend or supplement the battery life of an electric mobility scooter. Accordingly, the present disclosure makes specific reference thereto. Nonetheless, it is to be appreciated that aspects of the present invention are also equally applicable to other like applications, devices, and methods of manufacture.

### BACKGROUND

Many elderly, injured, or disabled individuals have difficulty walking. As a result, many retail stores supply electric mobility scooters to aid said individuals in moving about their retail stores. However, said scooters rely on an electric charge. Therefore, it is not uncommon for an individual to be using an electric scooter in a store and the battery of the scooter dies. This is frustrating for the individual, who then must flag down a store employee to replace the scooter. If they are physically unable to do this, the individual may be stranded at the location the scooter died until they are discovered by a store employee.

Therefore, there exists a long-felt need in the art for an improved scooter battery device. More specifically, there exists a long-felt need in the art for a scooter battery device that extends the battery life of an electric mobility scooter. There also exists a long-felt need in the art for a scooter battery device that allows a user to continue using an electric mobility scooter when the scooter dies, without help from a store employee.

The subject matter disclosed and claimed herein, in one embodiment thereof, comprises a scooter battery device. In two primary embodiments, the device can be used as a backup battery for an electric mobility scooter or as the main standalone battery of the scooter. In the first embodiment, a housing of the device is attached to the scooter and is in wired electrical communication with the existing battery of the scooter. A battery of the device can then be placed into the housing to supply additional power to the existing scooter battery when said existing battery dies. In the second embodiment, the housing has a plurality of batteries that can each be placed in a receiving port of the housing to provide power to the scooter as needed. For example, when a first battery dies, it can be switched with a second charged battery that is also stored in the housing.

In this manner, the scooter battery device of the present invention accomplishes all the foregoing objectives and provides an improved user experience for an electric mobility scooter. More specifically, the device extends the battery life of the scooter. In addition, the device also allows a user to change a dead battery easily, without the need for a nearby employee.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a scooter battery device. A first embodiment is comprised of a housing that receives at least one battery that can be retrofitted to an existing electric mobility scooter. The housing is in electrical communication with the existing battery of the electric mobility scooter via at least one wired connector. This embodiment of the device can be removably attached to an electric mobility scooter to operate as a backup battery in an event that the existing battery dies. In another embodiment, the device is used as the sole battery supply for an electric mobility scooter.

The housing is comprised of at least one receiving port that receives at least one removable battery. As a result, the battery can be placed into the housing as needed to provide backup or supplemental charge to the battery of the scooter if the battery dies. This is desirable, as the full battery need not be recharged immediately if it dies. Instead, the battery can be placed into the housing by a business employee or other individual. This allows the user of the scooter to continue using the same scooter without having to switch to a scooter with a full charge.

The battery can be charged by at least one charging device. The device is comprised of at least one charging port that receives the charging port of the battery. The charging port of the charging device may be any type of reciprocal receiver port for the battery charging port known in the art. The charging device may receive electrical power via at least one power cord.

The present invention may also be comprised of a method of use. First, a device is provided wherein the device is comprised of a housing with receiving port, a battery, and a charging device comprised of a charging port. The device may be in electrical communication with an existing battery of an electric mobility scooter or may function as a sole battery of the scooter. Then, the battery can be charged using the charging device by connecting the battery to the charging port. Next, the battery can be inserted into the receiving port located on the scooter to provide power to the scooter. When the battery dies, a second charged battery can be used to replace the first dead battery within the housing.

Accordingly, the scooter battery device of the present invention is particularly advantageous as it provides an improved scooter battery device. More specifically, the device extends the battery life of an electric mobility scooter by the use of interchangeable batteries. The device also allows a user to easily replace a battery, without help from a store employee, and continue using an electric mobility scooter when the scooter dies. In this manner, the scooter battery device overcomes the limitations of existing electric mobility scooters known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a scooter battery device of the present invention in accordance with the disclosed architecture;

FIG. 2 illustrates a perspective view of a battery and a charging device of one potential embodiment of a scooter battery device of the present invention in accordance with the disclosed architecture; and

FIG. 3 illustrates a flowchart of a method of using one potential embodiment of a scooter battery device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a scooter battery device. More specifically, there exists a long-felt need in the art for a scooter battery device that extends the battery life of an electric mobility scooter. There also exists a long-felt need in the art for a scooter battery device that allows a user to continue using an electric mobility scooter when the scooter dies, without help from a store employee.

The present invention, in one exemplary embodiment, is comprised of a scooter battery device. A first embodiment is comprised of a housing that receives at least one battery. The housing can be retrofitted to an existing electric mobility scooter and is preferably in electrical communication with the existing battery of the electric mobility scooter via at least one wired connector. This embodiment of the device can be removably attached to an electric mobility scooter to operate as a backup battery in the event that the existing battery dies. In another embodiment, the device is used as the sole battery supply for an electric mobility scooter.

The housing is comprised of at least one receiving port. The port receives at least one removable battery, wherein the battery can be placed into the housing as needed to provide backup or supplemental charge to the battery of the scooter if the battery dies. As a result, the full battery need not be recharged immediately if it dies. Instead, the battery can be placed into the housing by a business employee or other individual. This allows the user of the scooter to continue using the same scooter without having to switch to a scooter with a full charge.

The battery can be charged by at least one charging device. The device is comprised of at least one charging port that receives the charging port of the battery. The charging port of the charging device may be any type of reciprocal receiver port for the battery charging port known in the art. The charging device may receive electrical power via at least one power cord.

The present invention may also be comprised of a method of use. First, a device is provided wherein the device is comprised of a housing with receiving port, a battery, and a charging device comprised of a charging port. The device may be in electrical communication with an existing battery of an electric mobility scooter or may function as a sole battery of the scooter. Then, the battery can be charged using the charging device by connecting the battery to the charging port. Next, the battery can be inserted into the receiving port located on the scooter to provide power to the scooter. When the battery dies, a second charged battery can be used to replace the first dead battery within the housing.

Accordingly, the scooter battery device of the present invention is particularly advantageous as it provides an improved scooter battery device. More specifically, the device extends the battery life of an electric mobility scooter by the use of interchangeable batteries. The device also allows a user to continue using an electric mobility scooter when the scooter dies, without help from a store employee to easily replace a battery. In this manner, the scooter battery device overcomes the limitations of existing electric mobility scooters known in the art.

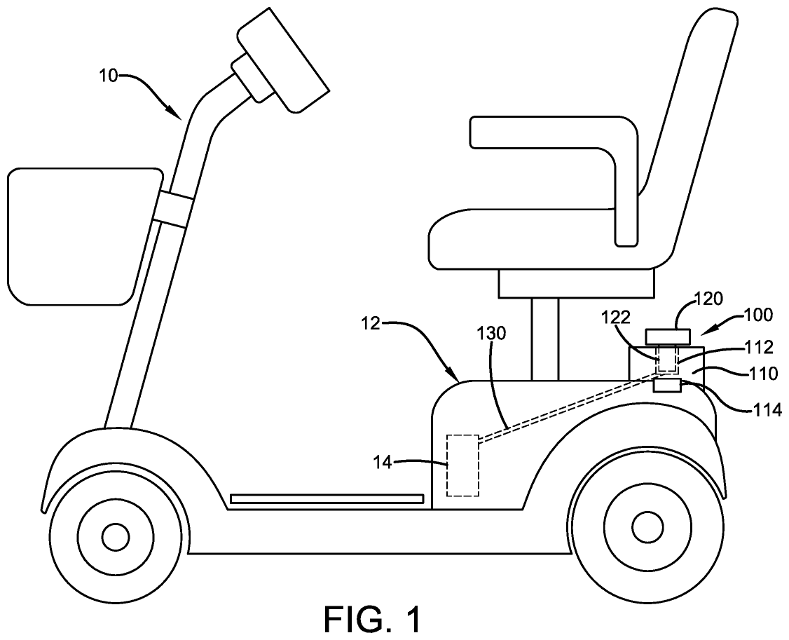

Referring initially to the drawings, FIG. 1 illustrates a side view of one potential embodiment of a scooter battery device 100 of the present invention in accordance with the disclosed architecture. The device 100 preferably has two main embodiments. A first embodiment is comprised of a housing 110 that receives at least one battery 120 that can be retrofitted to an existing electric mobility scooter 10. The housing 110 is in electrical communication with the existing battery 14 of the electric mobility scooter 10 via at least one wired connector 130.

This embodiment of the device 100 can be removably attached to an electric mobility scooter 10 to operate as a backup battery in an event that the existing battery 14 dies. The scooter 10 may be any electric scooter or electric chair that may be found in a business or institution to allow individuals with mobility issues to move around said business or institution. In this embodiment, the device 100 is not intended to replace, but rather only supplement, the existing battery 14 of the scooter 10. In a second embodiment, the battery 120 functions as the only battery supply for the scooter 10.

In this embodiment, the housing 110 may be attached to the body 12 of the scooter 10 via at least one fastener 114. The fastener 114 may be any type known in the art such as, but not limited to, a mounting bracket, a screw, a bolt, hook and loop fastener, a track and groove assembly, etc. In this manner, the device 100 does not require irreparable modification to the scooter 10.

The housing 110 is in electrical communication with the existing battery 14 of the scooter 10 via at least one wired connector 130, such as, but not limited to, an electrical wire. The housing 110 is comprised of at least one receiving port 112. The receiving port 112 receives at least one removable battery 120.

As a result, the battery 120 can be placed into the housing 110 as needed to provide backup or supplemental charge to the battery 14 of the scooter 10 if the battery 14 dies. This is desirable, as the full battery 14 need not be recharged immediately if it dies. Instead, the battery 120 can be placed into the housing 110 by a business employee or other individual. This allows the user of the scooter 10 to continue using the same scooter 10 without having to switch to a scooter 10 with a full charge.

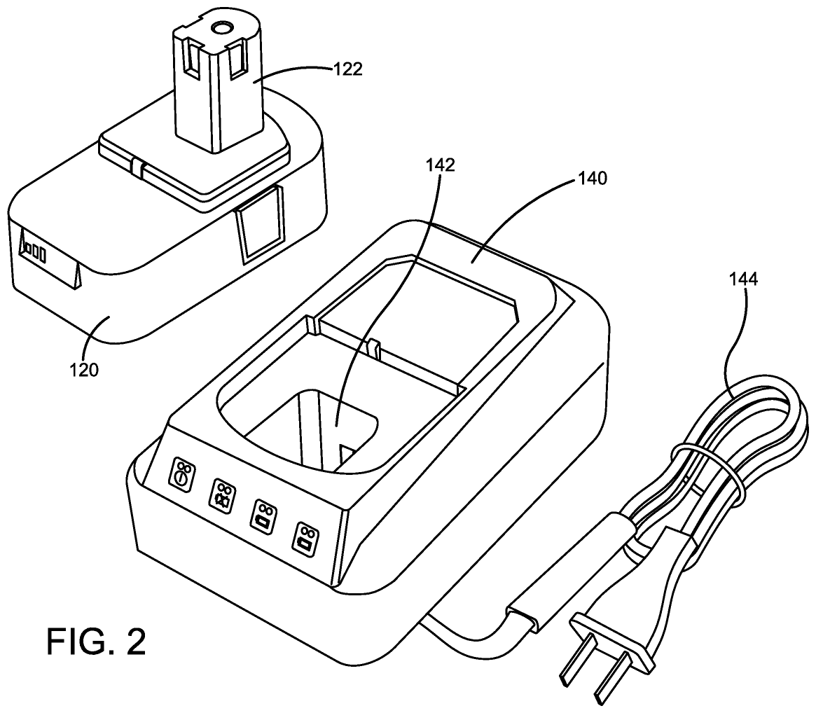

The battery 120 and receiver port 112 may be any type, style, configuration, etc., of battery and reciprocal receiver port 112 known in the art. The battery 120 can be charged by at least one charging device 140, as seen in FIG. 2. The charging device 140 can be kept at a secondary location accessible to customers and/or business employees.

The charging device 140 is comprised of at least one charging port 142 that receives the charging port 122 of the battery 120. The charging port 142 of the charging device 140 may be any type of reciprocal receiver port 112 for the battery 120 charging port 122 known in the art. The charging device 140 may receive electrical power via at least one power cord 144. The power cord 144 may be any type of power cord known in the art such as, but not limited to, a USB power cord or a 110v/240v plug.

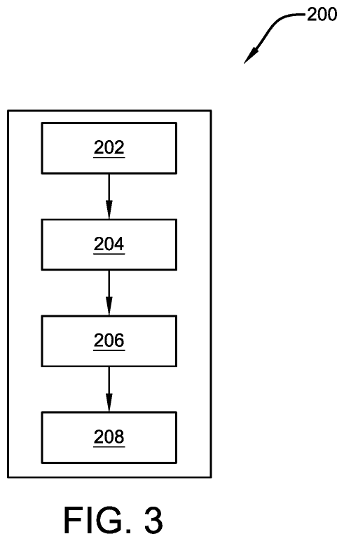

The present invention may also be comprised of a method of use 200, as seen in FIG. 3. First, a device 100 is provided wherein the device 100 is comprised of a housing 110 with a receiving port 112, a battery 120, and a charging device 140 comprised of a charging port 142 [Step 202]. In this embodiment, the device 100 may be in electrical communication with an existing battery 14 of an electric mobility scooter 10 or may function as a sole battery of the scooter 10. Then, the battery 120 can be charged using the charging device 140 by connecting the battery 120 to the charging port 142 [Step 204]. Next, the battery 120 can be inserted into the receiving port 112 located on the scooter 10 to provide power to the scooter 10 [Step 206]. When the battery 120 dies, a second charged battery 120 can be used to replace the first dead battery 120 within the housing [Step 208].

In one embodiment, the housing 110 accommodates a plurality of charged batteries 120. In this manner, a user of the scooter 10 can replace the dead battery 120 with another charged battery 120 stored in the housing 110. In this embodiment, all batteries 120 may supply power to the scooter 10 (and/or scooter battery 14). Alternatively, only one receiving port 120 of the housing 110 may actively draw power from one battery 120. As a result, once said battery 120 is dead, it can be replaced by another charged battery 120 that is being stored in another receiving port 112 that is not actively drawing power from said charged battery 120. In this manner, the receiving port 112 of charged batteries 120 are not being used to supply power to the scooter 10 and instead, simply functions as a storage holder for each battery 120.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “scooter battery device” and “device” are interchangeable and refer to the scooter battery device 100 of the present invention.

Notwithstanding the foregoing, the scooter battery device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the scooter battery device 100 as shown in the FIGS. are for illustrative purposes only, and that many other sizes and shapes of the scooter battery device 100 are well within the scope of the present disclosure. Although the dimensions of the scooter battery device 100 are important design parameters for user convenience, the scooter battery device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A scooter battery device comprising:
an electric scooter;
a housing attached to a body of the electric scooter, the housing comprised of a receiving port;
a battery comprised of a first charging port; and
a charging device comprised of a second charging port and a power cord.

2. The scooter battery device of claim 1, wherein the electric scooter is comprised of an electric mobility scooter.

3. The scooter battery device of claim 1, wherein the receiving port of the housing receives the battery.

4. The scooter battery device of claim 1, wherein the battery is removable from the receiving port.

5. The scooter battery device of claim 1, wherein the battery supplies power to the electric scooter.

6. A scooter battery device comprising:
a housing comprised of a receiving port;
a battery comprised of a first charging port;
a wired connector; and
a charging device comprised of a second charging port and a power cord.

7. The scooter battery device of claim 6 further comprised of a fastener.

8. The scooter battery device of claim 6, wherein the receiving port of the housing receives the battery.

9. The scooter battery device of claim 8, wherein the battery is removable from the receiving port.

10. The scooter battery device of claim 6, wherein the second charging port receives the first charging port.

11. The scooter battery device of claim 10, wherein the battery is removable from the second charging port.

12. The scooter battery device of claim 6, wherein the power cord is comprised of a 110v power cord.

13. The scooter battery device of claim 6, wherein the power cord is comprised of a 240v power cord.

14. A method of using a scooter battery device, the method comprising the steps of:
providing a scooter battery device, the scooter battery device comprised of a housing comprised of a receiving port, a first battery, and a charging device comprised of a charging port;
charging the first battery using the charging device; and
powering an electric scooter by placing the first battery into the receiving port.

15. The method of claim 14, wherein the scooter battery device is in a wired electrical communication with a battery of the electric scooter.

16. The method of claim 14, wherein the battery supplies power to the electric scooter.

17. The method of claim 14 further comprised of a step of removing the first battery from the receiving port when the battery is dead.

18. The method of claim 17 further comprised of a step of placing a second battery into the receiving port when the first battery has been removed.

19. The method of claim 14, wherein the charging device is comprised of a power cord.

20. The method of claim 14, wherein the charging device supplies power to the battery.
